(19) United States
(12) Patent Application Publication
(10) Pub. No.: US 2026/0042072 A1
(43) Pub. Date: Feb. 12, 2026

(54) AGITATOR, REACTOR, AND PROCESS

(71) Applicant: INEOS USA LLC, League City, TX (US)

(72) Inventors: Theo Victor HOREMANS, Eindhout (BE); Michael T. WILLIAMS, Charles Town, WV (US); Dirk POESEN, Zolder (BE)

(73) Assignee: INEOS USA LLC, League City, TX (US)

(21) Appl. No.: 18/797,424

(22) Filed: Aug. 7, 2024

(51) Int. Cl. B01F 27/112; B01J 19/18

(52) U.S. Cl. CPC B01F 27/112; B01J 19/18

(57) ABSTRACT

The present invention relates to an agitator, suitable for use in a reactor for the continuous vapor phase polymerization of one or more monomers, and in particular provides an agitator which comprises a central shaft and a plurality of stirring paddles, wherein each stirring paddle extends radially from the shaft, has a first surface and has a cross-section which comprises either a triangular cross-section, or a partial ellipsoidal cross-section, or a three-dimensional cross-section other than a triangular or partial ellipsoidal cross-section and which is such that in use there is no stagnant zone behind the first surface.

### BACKGROUND

The present invention relates to an agitator, and in particular for use in a reactor for the continuous vapor phase polymerization of one or more monomers.

The polymerisation of one or more monomers in gas/vapour phase reactors is well-known. (As used herein these two terms are used synonymously.) Known processes, particularly for propylene polymerisations for example, involve the reaction of one or more monomers in a mechanically stirred reactor which may be a vertically-orientated or a horizontally-orientated mechanically stirred reactor. For example, the polymerization of polymerizable monomers in horizontally-orientated mechanically stirred reactors has been described in a number of patents including U.S. Pat. Nos. 3,957,448, 3,965,083, 3,971,768 and 4,627,735.

Generally, in the polymerisation of propylene in a mechanically stirred reactor a bed of polypropylene polymer is maintained in an agitated state in the reactor. Above and within the bed is a vapour phase comprising unreacted propylene and other reactants, such as comonomers and hydrogen. The polymerisation reaction is highly exothermic, and to keep the reaction at the desired temperature it is known to withdraw the vapour and cool it prior to recycling. It is in particular common to partially condense the propylene and any other condensable components, and recycle to the reactor both a cooled vapour phase and a condensed liquid phase. Catalyst and fresh monomer are introduced to the reactor, whilst produced polymer is withdrawn to maintain the bed volume.

The bed of polymer in the reactor is continuously stirred by an agitator (stirrer). Typically this comprises a shaft around which are arranged a series of paddles or other types of stirring vanes, and which rotates during polymerization to stir/agitate the bed of polymer. The paddles or other types of stirring vanes inside the vessel sweep through the bed of polymer particles and stir the contents of the vessel. The known types of stirring vanes include staggered paddles, inclined paddles, spiral vanes, or vanes provided with a scraper for scraping the internal wall of the reactor vessel.

WO 99/29406 describes one form of an agitator which is known to be used in stirred polymerisation reactors. The agitator includes a plurality of flat planar paddles extending from a central shaft. A variant on this which is known includes a perpendicular support member behind the planar paddle, which give a “T-shaped” cross-section. (FIG. 1 herein reproduces FIG. 5 of WO 99/29406 to illustrate flat planar paddles and is described further below, whilst a schematic diagram of a single T-shaped paddle is shown in FIG. 2 herein.)

Another type of agitator, using a paddle known as a “gate paddle” is taught by U.S. Pat. No. 3,469,948. In this case planar paddles are supported on arms which extend from the shaft.

It has been found that the planar paddles of the type shown in WO 99/29406 and, especially, the gate paddles of U.S. Pat. No. 3,469,948 can become fouled by deposition/adherence of sticky polymer, which can form agglomerates, “strings” or “lumps” during use. These agglomerates, “strings” or “lumps” can be formed where growing polymer particles are not well mixed, and thus not exposed to the coolant, in the polymerisation reactor.

### SUMMARY OF THE INVENTION

In the present invention it has been found that the deposition of polymer on the paddles of the stirrer may be reduced by providing an improved design of the paddles.

Thus, in a first aspect the present invention provides an agitator which comprises a central shaft and a plurality of stirring paddles, wherein each stirring paddle extends radially from the shaft, has a first surface and has a cross-section which comprises either a triangular cross-section, or a partial ellipsoidal cross-section, or a three-dimensional cross-section other than a triangular or partial ellipsoidal cross-section and which is such that in use there is no stagnant zone behind the first surface.

The agitator is particularly for use in a mechanically stirred polymerisation reactor for the continuous vapor phase polymerization of one or more monomers.

Thus, in a second aspect, there is provided a mechanically stirred polymerisation reactor which includes, disposed within the reactor, an agitator according to the first aspect.

Further, in a third aspect, there is provided a process for the polymerisation of one or more monomers which process comprises polymerising said one or more monomers in a reactor which comprises an agitator according to the first aspect, and in particular in a reactor which is a mechanically stirred polymerisation reactor according to the second aspect. The central shaft of the agitator is generally as known in the art. In a reactor the shaft is generally disposed along the central axis of the reactor, and connected at one end to a suitable motor which can rotate the agitator in use.

### BRIEF DESCRIPTION OF THE DRAWINGS

The disclosure will become more fully understood from the following detailed description, taken in conjunction with the accompanying representative figures, wherein like reference numerals refer to like elements, in which:

FIG. 1 depicts a front side perspective view of a portion of the length of a prior art agitator which has a plurality of flat planar paddles extending from a central shaft.

FIG. 2 depicts a front side perspective view of a portion of another prior art agitator paddle.

FIG. 3 depicts a front side perspective view of a single paddle with a triangular cross-section.

FIG. 4a depicts a cross sectional plan view of a paddle having an equilateral triangle shaped cross-section.

FIG. 4b depicts a cross sectional plan view of a paddle having an isosceles triangle shaped cross-section.

FIG. 4c depicts a cross sectional plan view of a paddle having a non-symmetrical triangle shaped cross-section.

FIG. 5a depicts a cross sectional plan view of a paddle having two concave sides.

FIG. 5b depicts a cross sectional plan view of a paddle having two convex sides.

FIG. 5c depicts a cross sectional plan view of a paddle having a non-symmetrical and non-Euclidean shape.

FIG. 6 depicts a cross sectional plan view of a paddle having a semi-ellipsoid shape.

FIGS. 7a-7b depicts examples of cross-sectional views of paddles having 3 or more sides.

The drawings are not necessarily to scale and certain features may be shown exaggerated in scale or in somewhat schematic form in the interest of clarity and conciseness.

### DETAILED DESCRIPTION

Each stirring paddle extends radially from the shaft. The plurality of stirring paddles may be arranged in any suitable configuration. For example, the shaft may include a first set of stirring paddles, such as two, three, four or more stirring paddles, which extend radially from a first location along the length of the shaft, and then one or more further sets of stirring paddles, for example each set comprising two, three, four or more stirring paddles, which each extend radially from further locations (i.e. a second location, and optionally third, fourth locations etc) along the length of the shaft.

At each location the set of stirring paddles which are spatially separated from each other around the shaft. For example, 2 paddles would preferably be located on opposite sides of the shaft at a particular location (180° separation), whilst 3 paddles would preferably be separated by 120° from each other, 4 paddles by 90° from each other, etc.

Adjacent sets of stirring paddles may be, and preferably are, off-set from one another.

Preferred configurations of the multiple stirring paddles may, for example, be of the types of configuration described in WO 99/29406 (except with the individual stirring paddles being as claimed herein rather than flat plates as in WO 99/29406).

There may, in preferred embodiments, be 50-150 stirring paddles present in total.

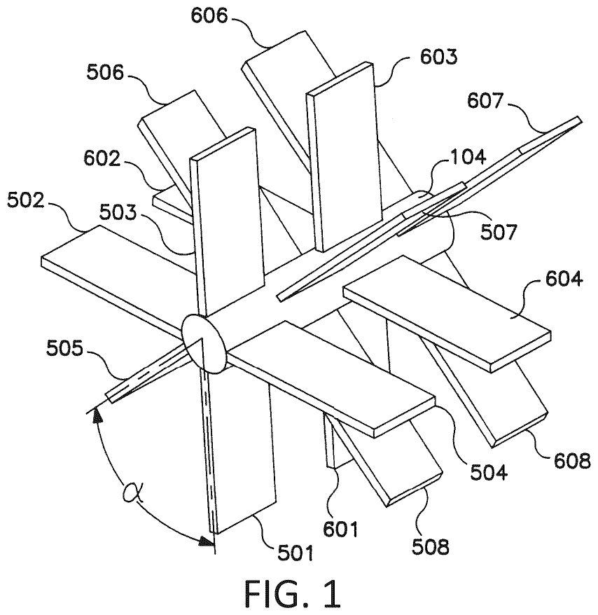

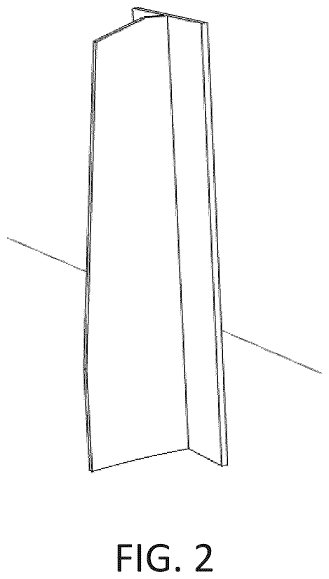

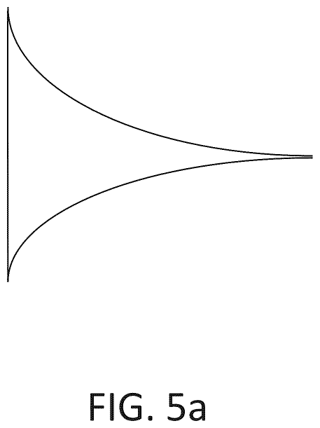

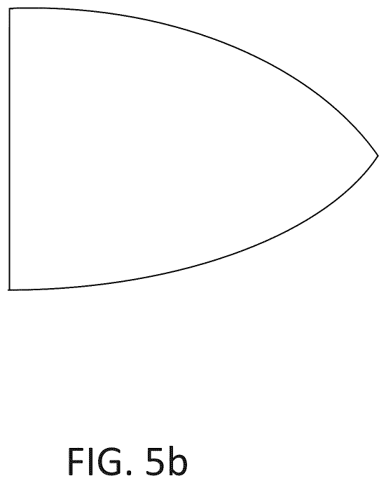

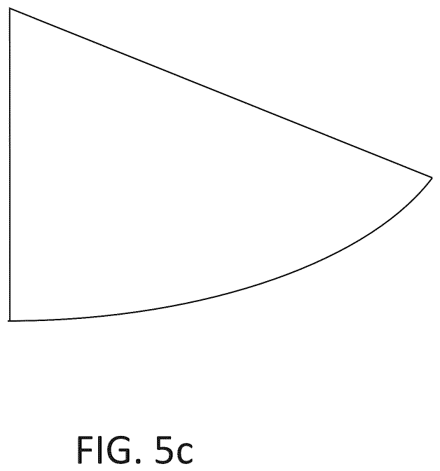

FIG. 1 herein represents one example of the prior art, and in particular reproduces FIG. 5 of WO 99/29406. FIG. 1 shows a portion of the length of an agitator which has a plurality of flat planar paddles extending from a central shaft 104. As shown in FIG. 1, there are four sets of four paddles. In each set as shown the 4 paddles are positioned at equal angular intervals of 90° around shaft 104. The first set comprises four flat paddles 501-504. The second set comprises paddles 505-508 which as shown are off-set by an angle “α” (alpha), which in this case is 45°, compared to paddles 501-504. Paddles 601-604 and 605-608 (605 is not visible as it is behind the shaft 104) form two further sets. Typically multiple such sets are found along the length of the agitator. As noted, preferred configurations of the multiple stirring paddles according to the present invention may be of the types of configuration described in WO 99/29406, including that shown in FIG. 1, except with the individual stirring paddles being as claimed herein rather than flat plates.

In many embodiments of the present invention each stirring paddle has a first surface. Most preferably the first surface is a flat first surface. However, this is not strictly necessary, and in some embodiments it may not be completely flat. For example the first surface could be slightly concave. (Note that for ease of reference herein, and also because it is preferred, we may refer to the agitator, such as its orientation and the shape of its cross-section on the basis of the front surface being flat. However, this does not preclude that this is not the case.)

In preferred embodiments, and in particular for use in a horizontally orientated stirred reactor, each stirring paddle is orientated such that the first surface is essentially parallel to the axis of rotation of the stirrer. In particular, in a horizontally orientated stirred reactor it is generally desired that the particles of polymer which form the polymer bed in the reactor traverse the length of the reactor essentially because of polymerization in the bed to form polymer and not by the effect of the agitator. This condition can be obtained by the design of the agitator to have a first surface essentially parallel to the axis of rotation, as this provides for radial agitation, but not for significant backward or forward axial movement of the polymer particles.

In general, the first surface should form a “front surface” of a stirring paddle when the agitator is rotated. The rest of the cross-section then forms the “rear” of a stirring paddle in the direction of rotation. The shapes as defined allow, in use, for smooth flow of the polymer bed over the rear of the stirrer as the stirrer rotates, and avoidance of stagnant spots behind the stirrer.

In one option, the cross-section of each stirring paddle may be triangular. As defined herein, “triangular” includes both Euclidian and non-Euclidian triangles. In both cases the paddle includes second and third surfaces which extend from either end of the first surface and meet at a line. In the cross-section the first, second and third surfaces form first, second and third sides of a triangle, where the second and third side meet at the third corner of the triangle. (And the third corner has an internal angle of less than 180°.)

“Euclidian triangles” have three straight sides (and a sum of the internal angles of 180°). In this case the triangle may preferably be an equilateral triangle (wherein the cross-section the second and third lines have the same length as the first line) or an isosceles triangle, although non-symmetric triangles may also be considered.

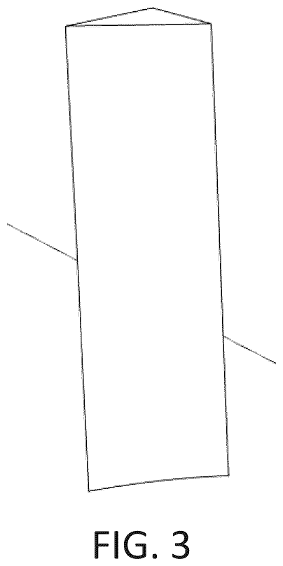

FIG. 3 shows a schematic diagram of a single paddle with a triangular cross-section according to the present invention. (In this Figure the first surface faces “away” from the viewer, whilst the surface facing the viewer is one of the second or third surfaces.)

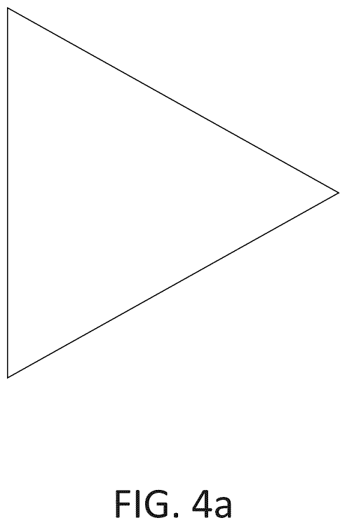

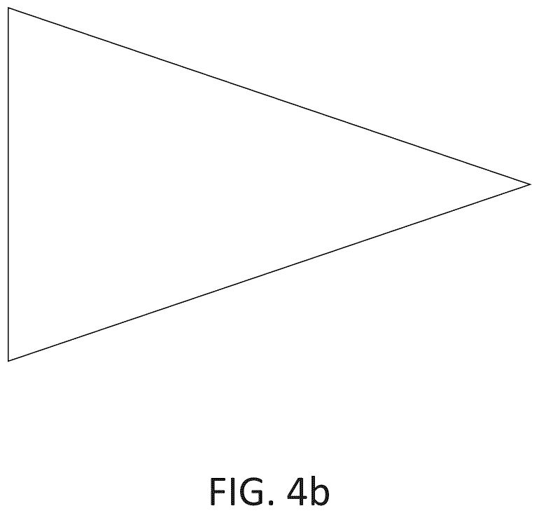

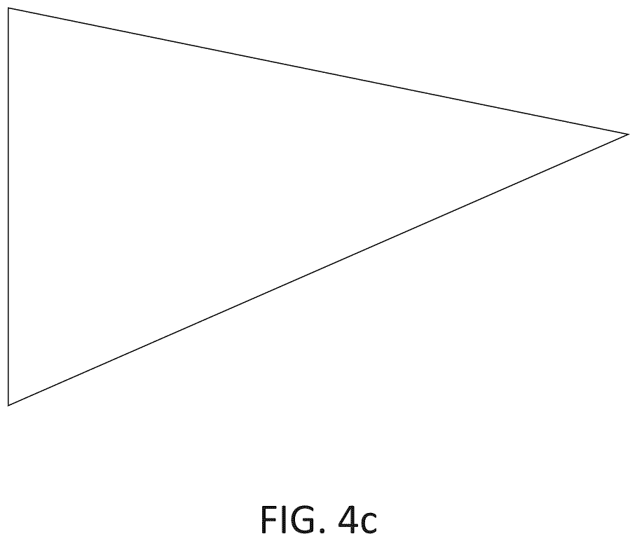

Some schematic examples of preferred cross-sections based on Euclidian triangles are shown in FIG. 4.

In 4a, for example, the cross-section is an equilateral triangle, whilst in 4b it is an isosceles triangle.

In 4c the cross-section is non-symmetric.

It should be note that as shown in FIGS. 4a-4c the corners where the first surface meets the second surface and the third surface respectively are shown as sharp vertices. In practise these corners may also be curved. As used herein, cross-sections with a first surface and curved corners to the second and third sides/surfaces are nevertheless still considered to be triangular cross-sections according to the present invention, and a similar position applies also to the other options for the cross-section.

A “non-Euclidian triangle” may have curved edges, and the sum of the internal angles may be more or less than 180°. In the present invention the term refers to a triangular cross-section with a first side (corresponding to a first surface) which is preferably flat, and either a curved second side, a curved third side, or both. Curved sides in cross-section may arise from a corresponding curved surface of the paddle.

Some schematic examples of preferred cross-sections based on non-Euclidian triangles are shown in FIG. 5.

In 5a, for example, the cross-section is triangular but the second and third sides are curved inwards (concave), whilst in 5b the second and third sides are curved outwards (convex). (It can be noted that 5b is still considered triangular as the second and third sides meet at a vertex (i.e. not a continuous curve). It will be apparent, however, that after the limit of this option this cross-section would become hemispherical as described for a further option in the present invention.)

In 5c the cross-section is non-symmetric, with one side being straight and the other side curved outwards. It will be apparent that other non-symmetric variations would also be suitable. For example, one side could be curved inwards (concave) and the other side curved outwards (convex).

In another option, the cross-section may be a partial ellipsoidal cross-section. In this the paddle includes second and third surfaces which extend from either end of the first surface, where in the cross-section the first, second and third surfaces form first, second and third sides but where the second and third side meet without forming a point. By this is meant that the second and third surfaces of the cross-section do not converge at a specific point but rather form a continuous curve.

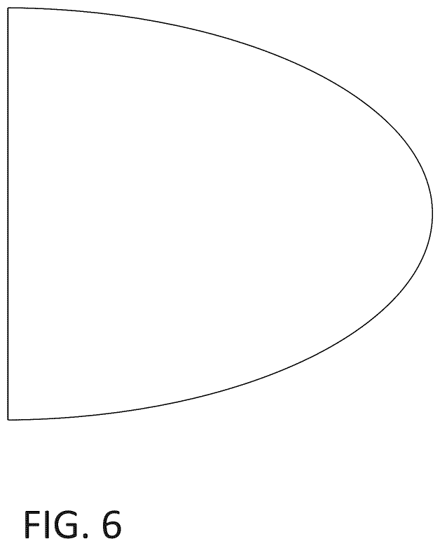

Examples include a semi-ellipsoid shape, such as a hemispherical cross-section. A schematic example of this is shown in FIG. 6.

In either of these first and second options the cross-section has a generally tapered shape. In use this allows smooth flow of the polymer bed over the rear of the stirrer as the stirrer rotates, and avoidance of stagnant spots behind the stirrer.

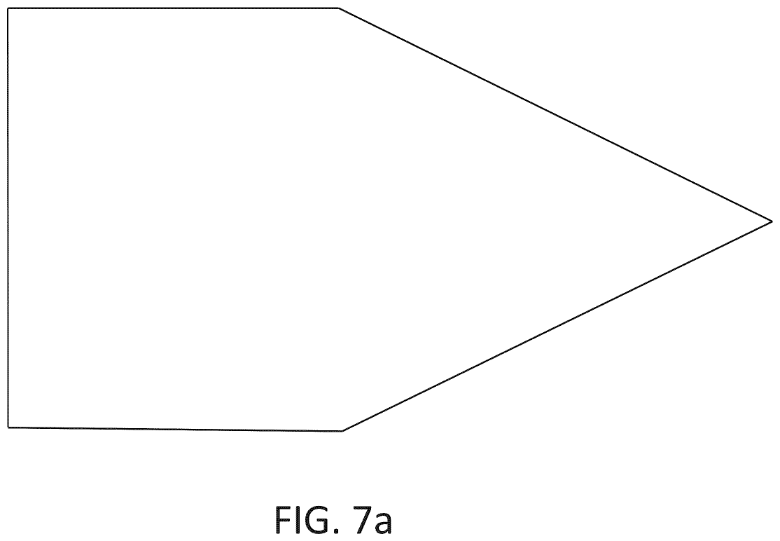

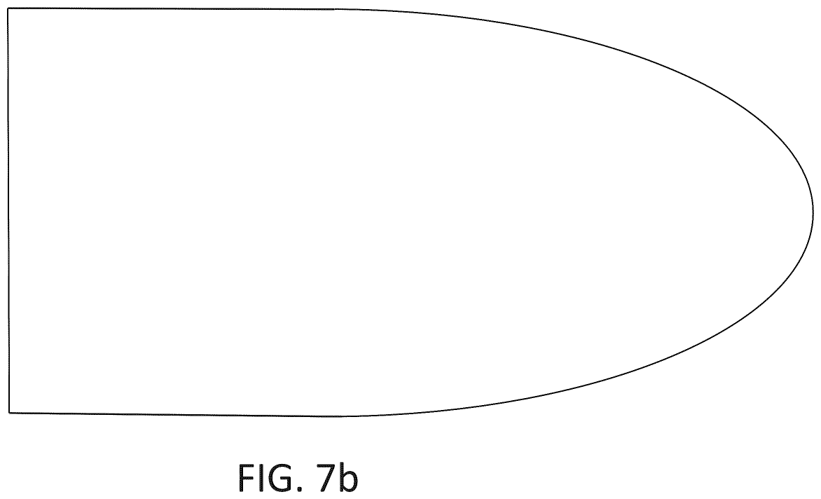

In a third option, the stirring paddles have a three-dimensional cross-section other than a triangular or partial ellipsoidal cross-section. Options include, for example, cross-sections which have a tapered profile, but which have more than 3 corners i.e., are not triangles or partial ellipses. The cross-section may, for example, have three, four or five sides other than the first surface. Some examples are shown in FIG. 7.

In general, whilst profiles within this third option can be contemplated which can provide the same effect as the options with a triangular cross-section or with a partial ellipsoidal cross-section, stirring paddles within this option are usually more complicated in shape than the other options (e.g. having more sides, and hence more corners or edges) and therefore also are more complicated to manufacture, and are less preferred.

The stirring paddles in all options may be made of any suitable material. Typically they are formed of steel, such as carbon steel or stainless steel. Stainless steel is preferred. The stirring paddles may be solid, or may be hollow or at least partly hollow e.g. formed of a sheet or sheets of metal which are shaped to the required external profile/cross-section leaving a hollow centre, or shaped around an internal support structure or frame to leave a profile which is partly hollow. The use of hollow or partly hollow stirring paddles has the advantage that the stirring paddles use less material and are lighter.

Preferably the surfaces of the stirring paddles are polished, for example electropolished. Preferably the surfaces are polished to an Ra (arithmetic average of surface heights) of less than 1 micron, preferably less than 0.5 microns. Preferably any joins or welds are polished, and in particular in this case are preferably mechanically polished.

The cross-section may vary along the length of the paddle (length as used herein being the direction extending radially from the shaft). However, in general, the cross-section should remain of a particular one of the defined options (triangular cross-section or a partial ellipsoidal cross-section or three-dimensional cross-section other than a triangular or partial ellipsoidal cross-section) along all, or at least the majority, of the paddle, even if the exact shape e.g. size or specific triangular shape may differ. For example, a paddle with triangular cross-section may have a relatively larger cross-section nearer to the shaft for strength reasons. Alternatively larger cross-section may be provided at the end remote from the shaft to enhance stirring nearer the outer edges of the reactor in which it is used.

The size of the agitator, and in particular, the length of the shaft and the length of the stirring paddles, is largely determined by the size of the reactor in which it is to be used. A typical commercial scale horizontally orientated mechanically stirred polymerisation reactor may, for example, have a length of 12 to 25 meters, and an internal diameter of 2 to 4 metres, and the agitator will be designed so that the shaft extends inside the reactor as far along the internal reactor length as possible and so that the outer ends of the stirring paddles rotate as close as possible (allowing for suitable tolerances in design and operation) to the inner surface of the reactor. Typically, in a horizontally orientated stirred reactor, for example, the clearance between the end of a stirring paddle and the inner surface of the reactor, measured between the end of the stirring paddle at its lowest vertical point during its rotation and the inner surface at the bottom of the reactor, is less than 50 mm, such as in the range 5 to 50 mm, and more preferably less than 30 mm, such as less than 10 mm. In a vertically orientated stirred reactor similar clearances are preferred, but in this case these are based on the clearance between the end of the stirring paddle and the inner surface of the vertical wall of the reactor.

In general, the agitator central shaft may have a diameter of 300 to 1750 mm and a length of 9 to 25 meters (with larger diameter generally being required for longer shafts). The stirring paddles may have an individual length of 500 to 1950 mm.

Each stirring paddle will typically have a first surface of area 0.1 and 1.5 m2. The width of the first surface is generally from 150 to 750 mm.

In relation to the second aspect of the present invention, other than the agitator of the present invention, the mechanically stirred polymerisation reactor for the continuous vapor phase polymerization of one or more monomers will generally be as known in the art.

The reactor is preferably a horizontal stirred bed reactor. Such reactors are well known, for example as described in WO 2011/155999. The reactor in the second aspect of the present invention may be a single (“stand alone”) reactor, or may be one of two or more reactors, especially two or more horizontal stirred bed reactors, operated in series or in parallel. Series operation of two reactors is described, for example, in U.S. Pat. No. 6,069,212. Where two or more reactors are present then the agitator of the present invention can be used in one or all reactors as required. In a preferred embodiment the present invention is applied in at least the second reactor of two or more horizontal stirred bed reactors operated in series.

It should be noted, and as described in WO 2011/155999, each reactor may comprise several sections or zones. The agitator should extend through all zones in such a scenario, with stirring paddles being provided in each zone.

As noted, the reactor may have, have a length of 12 to 25 meters, and an internal diameter of 2 to 4 metres.

The reactor (excluding the stirrer, any settling domes and any internals) typically has an internal volume of between 40 and 300 m3. During polymerisation typically between 25 and 80% of this volume is occupied by polymer present as a bed of polymer solids in the reactor, whilst 20-75% of the volume is gas volume (to include both the gas/vapour above the bed of polymer and also within the bed between the polymer particles). Typically, one or more, such as one or two settling domes are mounted on the top of the reactor.

The reactor is typically connected to a condenser, and in particular a gaseous (vapour) stream is withdrawn from the reactor, usually via the settling domes when present, and passed to the condenser in which it is partly condensed to produce a liquid phase and a remaining vapour phase. The condenser is usually connected to a separator in which the vapour phase and the liquid phase are separated, and this is usually connected back to the reactor so that both the vapour phase and liquid phase can be recycled to the reactor.

The reactor, condenser, separator and connecting pipework (including pumps, valves etc.) may be considered as a reactor system.

In relation to the third aspect of the present invention, other than the use of an agitator (or reactor) of the present invention, the process for the polymerisation of one or more monomers will also generally be as known in the art.

The one or more monomers preferably comprises one or more monomers selected from C2 to C6 olefins, with ethylene and/or propylene, being preferred. The reaction mixture may further comprise hydrogen and/or one or more condensable components other than monomer, particularly inert hydrocarbons, which can be condensed and recycled to the reactor in the liquid phase wherein they are vaporised to aid removal of the exothermic heat of polymerisation. The third aspect of the present invention is most preferably applied to the production of polypropylene, in which case the one or more monomers comprises propylene. Monomers other than propylene may be present as comonomers, with ethylene and 1-butene being suitable examples.

The polymerisation may take place using any suitable catalyst. Well-known types of catalyst included chromium (or “Phillips”) catalysts, Ziegler-Natta catalysts and metallocene catalysts. Mixtures of catalysts may be used, for example to give bimodal products from a single reactor.

The process of the third aspect may, in particular, comprise the following steps:
a. Polymerising a mixture comprising one or more monomers and hydrogen in the reactor in the presence of a catalyst to produce a polymer,
b. Withdrawing from the reactor a gaseous stream,
c. Passing the gaseous stream to a condenser in which it is partly condensed to produce a liquid phase and a remaining vapour phase,
d. Passing the mixture of liquid phase and remaining vapour from the condenser to a separator in which there is maintained a liquid phase and a vapour phase,
e. And recycling both liquid and vapour from the separator to the reactor.

In particular, the ratio of vapour phase to liquid phase recycled to the reactor may be adjusted as required to maintain the temperature of the reactor at the desired set-point.

The preferred embodiments of the third aspect are as for the first and second aspects. For example, the process may take place in a reactor which is preferably a horizontal stirred bed reactor.

What is claimed is:

1. An agitator which comprises a central shaft and a plurality of stirring paddles, wherein each stirring paddle:
extends radially from the shaft;
has a first surface; and
has a cross-section which comprises either:
a triangular cross-section, or
a partial ellipsoidal cross-section, or
a three-dimensional cross-section other than a triangular or partial ellipsoidal cross-section and which is such that in use there is no stagnant zone behind the first surface.

2. The agitator according to claim 1 wherein the shaft includes a first set of stirring paddles which extend radially from a first location along the length of the shaft and which are spatially separated around the shaft, and then one or more further sets of stirring paddles, which each extend from further locations along the length of the shaft.

3. The agitator according to claim 1 wherein the first surface of each stirring paddle is essentially parallel to the direction of rotation of the stirrer, and is such that it is a “front surface” of the stirring paddle when the agitator is rotated.

4. The agitator according to claim 1 wherein the cross-section is triangular.

5. The agitator according to claim 4 wherein the triangular cross-section is in the form of an equilateral triangle or an isosceles triangle.

6. The agitator according to claim 4 wherein the triangular cross-section is in the shape of a “non-Euclidian triangle” with one or more curved edges.

7. The agitator according to claim 1 wherein the cross-section is partial ellipsoidal cross-section.

8. The agitator according to claim 1 wherein the stirring paddles have a three-dimensional cross-section other than a triangular or partial ellipsoidal cross-section, and which is such that in use there is no stagnant zone behind the first surface.

9. The agitator according to claim 1 wherein the stirring paddles are formed of polished steel, preferably with an Ra of less than 1 micron.

10. The agitator according to claim 1 wherein the stirring paddles are hollow or partly hollow.

11. The agitator according to claim 1 wherein the cross-section varies along the length of the stirring paddles and in particular the stirring paddles have a relatively larger cross-section nearer to the shaft.

12. A mechanically stirred polymerisation reactor for the continuous vapor phase polymerization of one or more monomers which includes, disposed within the reactor, an agitator according to claim 1.

13. A reactor according to claim 12 wherein the reactor is a horizontal stirred bed reactor.

14. A process for the polymerisation of one or more monomers which process comprises polymerising said one or more monomers in a reactor which comprises an agitator according to claim 1, and preferably where the reactor is a mechanically stirred polymerisation reactor for the continuous vapor phase polymerization of one or more monomers.

15. A process according to claim 14 wherein the process is a process for the production of polypropylene from one or more monomers comprising propylene.

16. A process according to claim 14 which comprises the following steps:
a. Polymerising a mixture comprising one or more monomers and hydrogen in the reactor in the presence of a catalyst to produce a polymer,
b. Withdrawing from the reactor a gaseous stream,
c. Passing the gaseous stream to a condenser in which it is partly condensed to produce a liquid phase and a remaining vapour phase,
d. Passing the mixture of liquid phase and remaining vapour from the condenser to a separator in which there is maintained a liquid phase and a vapour phase,
e. And recycling both liquid and vapour from the separator to the reactor.
